(19) United States
(12) Patent Application Publication
(10) Pub. No.: US 2025/0022446 A1
(43) Pub. Date: Jan. 16, 2025

(54) Systems And Methods For Intervallic Music Creation

(71) Applicant: Eventide Inc., Little Ferry, NJ (US)

(72) Inventors: Leon Gruenbaum, Brooklyn, NY (US); Joseph R. Waltz, Akron, OH (US); Stephen De Furia, Granada Hills, CA (US)

(73) Assignee: Eventide Inc., Little Ferry, NJ (US)

(21) Appl. No.: 18/221,519

(22) Filed: Jul. 13, 2023

(51) Int. Cl. G10H 1/06; G10H 1/00

(52) U.S. Cl. CPC G10H 1/06; G10H 1/0008; G10H 2210/056; G10H 2210/066; G10H 2210/081; G10H 2210/555; G10H 2220/121

(57) ABSTRACT

The present disclosure provides systems and methods by which music can be created and played by automatically defining a set of pitches that can be selected based on interval changes for pitch values within the set. A set of available pitches within a particular series can be referred to as a pitch palette, wherein each available pitch within the pitch palette is associated with being some predefined interval from any other pitch within the pitch palette. In accordance with aspects of the disclosure, a device may be configured to automatically identify particular pitch palettes that correspond with certain pitches or with particular pieces of music.

### BACKGROUND OF THE INVENTION

Creating and playing music can be an enjoyable and rewarding experience, however it often takes a large amount of time and effort to learn how to create and play music using standard instruments. Prior to putting in such time and effort, most people are not capable of creating and playing music that is pleasing to the car. In many circumstances, people who do not know how to play an instrument would like to be able to play music. For example, children often want to play along with music that is being played in their surroundings. What is needed are improved methods and systems for creating and playing music, which can be made accessible to people of all skill levels, including children.

### BRIEF SUMMARY OF THE INVENTION

In accordance with aspects of the disclosure, systems and methods are provided whereby individuals of varying musical skill levels, including young children and complete novices, are able to create and play music. The disclosed systems and methods may include a child-friendly device that is configured to automatically select a set of pitches, or pitch palette, that can be played on the device at a given time. These pitches can be played by the user of the device selecting device inputs that are assigned with interval step values within the set of pitches. Moreover, the set of pitches can be selected by the device based on pitch-related input that is received by the device. This pitch-related formation may include an electronic transmission of music or may include audible inputs from the device's surroundings. By selecting the set of pitches in the manner described herein, individuals with little or no musical background will be able to play along with music that is being played in their surroundings in a manner that is easy and enjoyable.

In accordance with aspects of the disclosure, systems and methods for playing music are provided that comprise one or more processors being configured to: receive a first set of signals corresponding to a first audible input; identify, based on the first set of signals, one or more pitches within the first audible input; determine a first pitch palette corresponding to the one or more pitches; receive user input at a device having a plurality of device inputs, wherein each of the plurality of device inputs are associated with a predetermined interval change value within the first pitch palette; and provide a first plurality of output signals corresponding to a first sequence of output pitch values, wherein each of the output pitch values are within the first pitch palette, and wherein at least a subset of the output pitch values are based on the predetermined interval change value of the user input relative to a previous pitch value within the first sequence.

In accordance with additional aspects, the one or more processors may be further configured to: receive a second set of signals corresponding to a second audible input; identify, based on the second set of signals, one or more pitches within the second audible input; determine a second pitch palette corresponding to the one or more pitches of second audible input; receive user input at the device from the plurality of device inputs; and provide a second plurality of output signals corresponding to a second sequence of output pitch values, wherein each of the output pitch values of the second sequence are within the second pitch palette. The first pitch palette may correspond to a first set of notes within a scale of a first musical key, and the second pitch palette may correspond to a second set of notes within a scale of a second musical key.

In accordance with other aspects of the disclosure, the first audible input may include a plurality of sound sources and identifying the one or more pitches within the first audible input further may comprise identifying a sound source, from the plurality of sound sources, for each of the one or more pitches. Identifying the sound source for each of the one or more pitches may include identifying an instrument type for the one or more pitches.

In accordance with still other aspects, the one or more processors may be further configured to place the device into a musical complexity mode from a plurality of musical complexity modes, and wherein the first pitch palette is determined, at least in part, by the musical complexity mode. The processors may be further configured so that when the device is in a first musical complexity mode, the first pitch palette is based on a pentatonic scale, and wherein when the device is in a second musical complexity mode, the first pitch palette has more than five notes.

In accordance with yet other aspects, the one or more processors may be further configured to provide the first audible input to a machine-learning algorithm that has trained using music data that has been associated with particular pitch palettes, and wherein the first pitch palette is based on an output of the machine-learning algorithm. The one or more processors may be further configured to provide for display on the device an indication of the first pitch palette.

In accordance with other aspects, systems and methods for playing music are disclosed in which one or more processors may be configured to: receive a first set of signals corresponding to a first pitch-related input; determine a first pitch palette of available pitches corresponding to the first pitch-related input; associate a plurality of device inputs with the first pitch palette of available pitches, wherein each device input corresponds with a predetermined interval change value relative to a previously-played pitch value; receive user input selecting one of the plurality of device inputs; provide a signal for a pitch to be played that corresponds with the user input; receive a second set of signals corresponding to a second pitch-related input; determine a second pitch palette of available pitches corresponding to the second pitch-related input; and associate the plurality of device inputs with the second row of available pitches. At least one pitch may be a part of either the first pitch palette or the second pitch palette but is not a part of both the first pitch palette and the second pitch palette.

### BRIEF DESCRIPTION OF THE DRAWINGS

FIG. 1 is a block diagram of a device in accordance with aspects of the disclosure.

FIGS. 2-4 are front views of a device playing music in accordance with aspects of the disclosure.

FIG. 5 is a flow chart in accordance with aspects of the disclosure.

FIG. 6 is a diagram of a system that includes a plurality of user devices in accordance with aspects of the disclosure.

FIG. 7 is a front view of a device having a plurality of keys in accordance with aspects of the disclosure.

FIG. 8 is a front view of a music device having a user interface in accordance with aspects of the disclosure.

FIG. 9 is a display in accordance with aspects of the disclosure.

FIGS. 10-12 are front views of a music device with displays in accordance with aspects of the disclosure.

FIGS. 13 and 14 are opposite side views of a music device in accordance with aspects of the disclosure.

### DETAILED DESCRIPTION

The present disclosure provides for systems and methods by which music can be created and played by automatically defining a set of pitches that can be played by a user. The notes from the set of pitches can be identified based on providing an input that identifies an interval change of pitch value relative to another pitch value within the set. The set of available pitches at a given time can be referred to as a pitch palette, wherein each available pitch within the pitch palette is associated with being some predefined interval from any other pitch within the pitch palette. In accordance with aspects of the disclosure, a device may be configured to automatically identify particular pitch palettes that correspond to, or are compatible with, certain pitches or with particular pieces of music. The device may also allow a user of the device to create new music by providing inputs that identify interval changes within the pitch palette. By automatically assigning the pitch palette based on received pitch-related inputs, a novice, including small children, could use the device to play music that is compatible with other music that has been or is being played.

A pitch palette that is used may take the form of a scale or other subset of notes that has a root, with each pitch within the pitch palette having a unique interval from the root in accordance with a particular musical key or mode. For example, a pitch palette may be created by taking the note C as a root note and then identifying the standard pitches that are included in the Western major diatonic scale, with each of the pitches within the pitch palette being within the major diatonic scale for the key of C, and with each pitch being associated with an interval value relative to the note C.

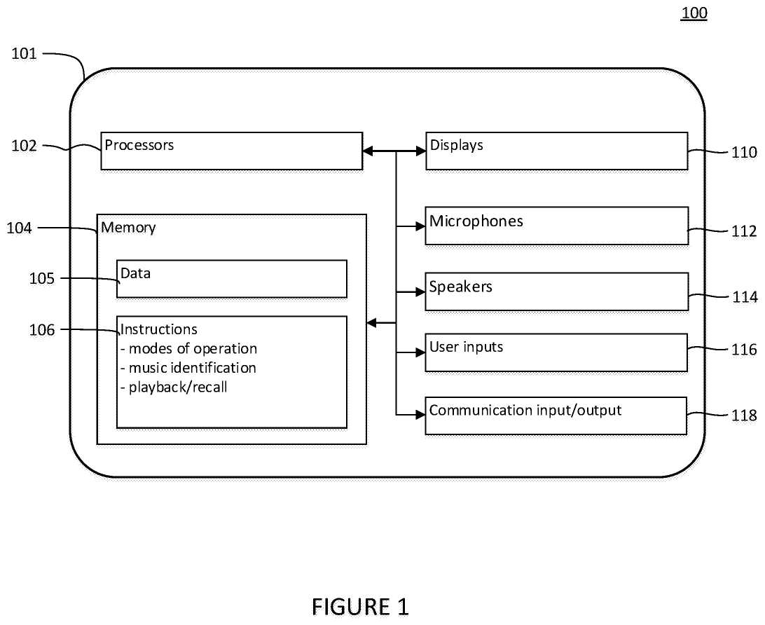

FIG. 1 is a block diagram 100 of a device 101 that is configured to operate in a manner to play music in accordance with aspects of the current disclosure. Device 101 may include one or more processors 102 that are in communication with memory 104. The memory may include data 105 and instructions 106. The device 101 may also contain displays 110 for providing a visual display for the device 101, microphones 112 for receiving audible inputs, and speakers 114 for providing audible outputs. The device 101 may also include user inputs 116, which can take the form of buttons, switches, scrollers, or the like, and which are configured to receive an input from the user of the device. The device 101 may also be configured to send and receive signals to and from external devices using communication inputs/outputs 118. For example, the communication inputs/outputs 118 may include Internet connections, as well as antennae for transmitting and receiving Wi-Fi, Bluetooth, or cellular transmissions.

The processors 102 of device 101 may be configured to receive and analyze audible inputs from speakers 114. The analysis of the audible input may include identification of one or more pitches within the audible input. The analysis may also include determining whether the pitches correspond to particular musical modes or keys. The device 101 may also be configured to select a particular pitch palette based on the analysis of the audible input and allow the user to play music that is based on the selected pitch palette.

For example, if the user, or other individual, is singing a song that consists of notes or chords that are within a C-major scale, the processors 102 may access instructions 106 and data 105 to identify the pitches of the audible input as being consistent with the key of C-major or in the C-Ionian musical mode. The processors 102 may select a pitch palette that is made of the various pitches within the C-major scale and allow a user of device 102 to select particular intervals within the selected pitch palette. The notes that are based on the user selected intervals can be played from speakers 114 of device 101 and can also be transmitted to another device via communication outputs 118.

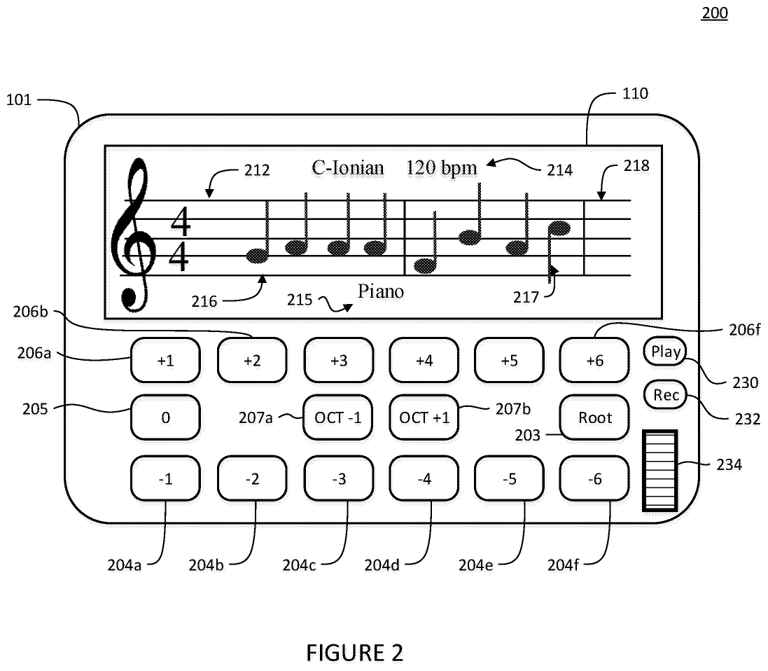

An example of this can be seen in diagram 200 of FIG. 2, in which device 101 is being used to play a series of notes in the key of C-major. In this example, device 101 has been put into a mode of operation whereby it can receive audible input from its surroundings, such as by the user of device 101 selecting the record button 232. Upon receiving audible input, device 101 can identify any pitches that are included within the input. Based on one or more of the identified pitches, device 101 can select a pitch palette that corresponds to the pitches of the audible input. As shown in FIG. 2, display 110 of device 101 may include a display area 214 identifying information regarding the audible input that has been recorded. For example, display area 214 of device 101 indicates that the audible input is based on pitches that correspond to the C-Ionian musical mode and that the music is being played at 120 beats per minute (bpm). The tempo of the music may vary as device 101 is being used, or it may be determined that the music being played does not have a particular tempo. In addition, display area 214 could be configured to display sets of notes as chords, and the display can provide information as to the name of the chord, such as by identifying a chord as being a C-major chord, a diminished chord, a seventh chord, or the like.

Device 101 can be configured to display the notes that have been and are being played by the device. The played notes 216 may be displayed in accordance with a series of musical bar 212, which can include clefs, time signatures, and key signatures of the music that is being played. For example, if device 101 has selected a particular pitch palette that corresponds to a key signature, that particular key signature may be automatically displayed within musical bars 212 upon the selection of the pitch palette. While FIG. 2 shows quarter notes being played, the device may play any other notes, such as sixteenth, eighth, half, and whole notes. The length of the note may be based on how long a particular user input is pressed by the user.

In diagram 200, device 101 has selected a pitch palette of pitches from the C-major scale, which are the notes C, D, E, F, G, A, and B. In accordance with aspects of the disclosure, the user of device 101 can proceed to play notes on device 101 by selecting from the plurality of intervallic user inputs 204-207. The intervallic user inputs 204-207 can each designate a particular interval change, within the pitch palette, of pitch values relative to the previous note that has been played. In particular, each of the user inputs 204a-f corresponds with playing a lower note than the previously-played note by a particular number of interval steps within the pitch palette of the C-major scale, while the user inputs 206a-f correspond with playing a higher note than the previously-played note by a particular number of interval steps within the pitch palette of the C-major scale. In addition, user input 205 corresponds with an intervallic change of zero, meaning that the previously played note would be repeated. In addition, user inputs 207a and 207b can allow the user to play a note that is an octave below or above the previously played note, respectively. Device 101 may also contain a user input 203 that can be used to play the root note for a selected pitch palette.

Device 101 may also have additional user inputs, such as scroller 234, Root button 203, and Play button 230. Scroller 234 can be used to scroll to selectable items within display 110. The play button 230 may be used to play previously recorded music, which may be based on music recorded as an audible input to device 101 or may be music that has been previously played on device 101. In addition, device 101 may be configured to combine music played on device 101 with music that was previously recorded as an audible input, so as to generate a new, combined piece of music.

Display 110 may also contain a display area 215 that identifies the type of instrument that is being simulated by the device. For example, in diagram 200, display area 215 indicates that the device 101 is simulating a piano, which means that the audible output of device 101 will resemble the sound and timbre of a piano. In accordance with aspects of the disclosure, the user of device 101 may select from a list of potential instruments, whereby device 101 will play selected pitches using the sound and timbre of the selected instrument.

Display 110 of FIG. 2 indicates that note 217 is the last note that has been played, which corresponds to a C note. Accordingly, if the user were to select user input 204a the next note played would be one step lower in the pitch palette of the C-major scale, meaning that device 101 would play a B note, while if user input 204b was selected, the next note played would be two steps lower in the pitch palette of the C-major scale, meaning that device 101 would play an A note. Similarly, if user input 206a is selected, a D note would be played, as it is one step above C within the selected pitch palette, while user input 206b would cause device 101 to play an E note, as it is two steps above C within the pitch palette.

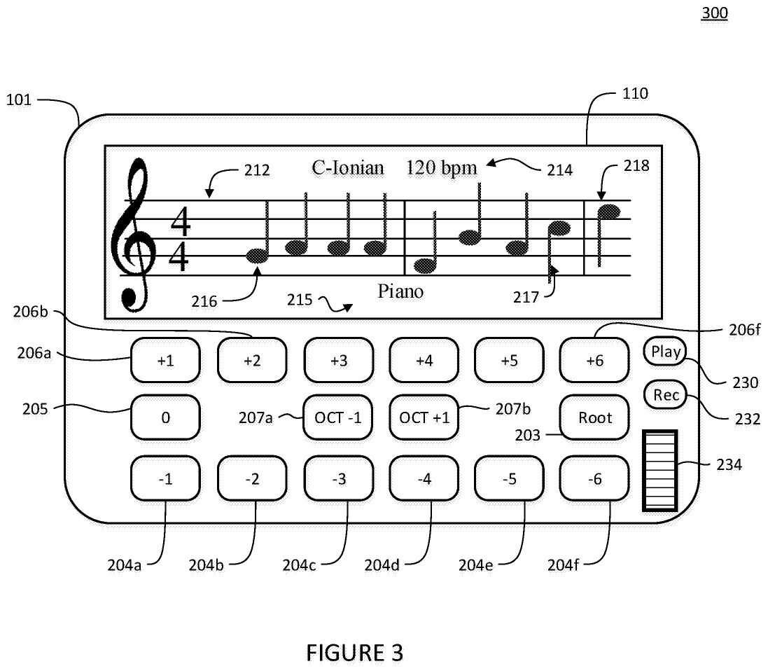

The next note in the series of notes played by device 101 can appear in display area 218. For example, diagram 300 of FIG. 3 is an example of device 101 of FIG. 2 in which user input 206b is being selected by a user. Thus, the pitch that is played by device 101 will be a E note, as that is two steps above the C note within the pitch palette of the C-major scale. When this E note is played, it can be displayed at display area 218. The display of musical bars 212 within display 110 may then to scroll to the left, so that additional notes may be displayed as the user continues to play additional notes on device 101. The display 110 may be configured to display some predetermined number of the most recent bars or notes that have been played on device 101. In addition, when the user has finished playing a sequence of notes, display 110 of device 101 may be configured so that a user can scroll through the musical bars 212 to see all of the previous notes that were played in the sequence.

In accordance with aspects of the disclosure, the device 101 may be configured to continue to analyze and record audible input signals while a user is using device 101 to play music. In addition, device 101 may be configured to continue to identify pitch-related information from the audible input, and to determine whether a new pitch palette should be selected by device 101. For example, in FIG. 2, device 101 has selected a pitch palette that corresponds to the C-Ionian mode, meaning that the available pitches for the user to play are notes from the C-major scale. The selection of this pitch palette may have been based on audible input that was received by a microphone of device 101, such as receiving audible input in which a person is singing or playing a song that was in the key of C-major, or receiving audible input of a recorded piece of music. However, while the user of device 101 plays music using the selected pitch palette corresponding to the C-major scale, the music may switch to another key or musical mode. For example, while device 101 is being played, it may begin to receive audible input that corresponds to a key of C-minor.

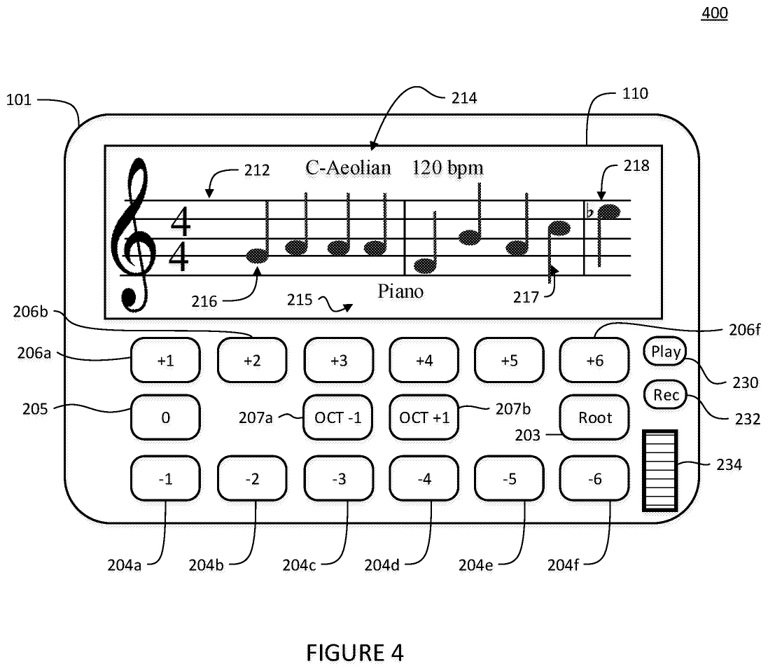

Upon performing an analysis of this audible input, device 101 may be configured to be in an operational mode in which it automatically selects a new pitch palette that corresponds more closely with the C-minor key of the audible input. This can be seen in diagram 400 of FIG. 4, wherein after the C note 217 is played, user input 206b is selected, so that an E-flat note is played by device 101 and is displayed at display area 218. This E-flat note is not a part of the C-major scale and was not a part of the original pitch palette for the previously played notes 216. However, as shown in display area 214, device 101 has changed the current pitch palette from C-Ionian to C-Aeolian. Within this new pitch palette, the notes of the C-minor scale are made available, and the note of E-flat is two steps above C. Thus, under the new pitch palette, selection of user input 206b will produce the note E-flat, rather than the note E, which would have been produced under the original pitch palette. In accordance with embodiments of the disclosure, if the pitch palettes correspond to a particular key signature, the musical bars 212 can be updated to include the particular key signature for particular measures in which the pitch palette has been changed. In other instances, device 101 may be set by the user so that it does not change the pitch palette that is presented to the user unless it is receives a user input indicating that a pitch palette change is desired. Upon receiving this user input, device 101 may analyze audible input that has been recently received or is currently being received and may then update the pitch palette that is presented to the user based on the analyzed audible input.

In other instances, the audible input received by device 101 may be a piece of music that alternates keys, including alternating keys in some repeatable fashion. In accordance with aspects of the disclosure, device 101 may identify any pattern in the key changes within the music, and it may automatically update the pitch palette that is presented to the user in accordance with the identified pattern of key changes. For example, if the audible input is a song that has a chorus that is in a different key than the verses of the song, then device 101 can be configured so that a first pitch palette is presented during a verse of the song and a different pitch palette is presented during the chorus of the song. In addition, device 101 may be configured to identify chord progressions within a piece of music, and the pitch palette that is made available to the user may be based on the identified chord progressions. These chord progressions could also be displayed to the user, and the user may be able to select from previously identified chord progressions. In addition, display 110 can be configured to display the particular chords or chord progression that is identified in the audible input, or other pitch-related input, that is received by device 101. In this way, device 101 can provide the user with an identification of chords that are being played in the user's environment or within some pre-recorded piece of music.

If the received audible input is based on a known musical composition, the pattern of key changes may be identified by accessing a database of music. For example, information regarding a particular piece of music may be stored in a database that includes metadata identifying the key changes of that particular piece. Even if the audible input is not based on a known musical composition, device 101 may be configured to identify key changes within the audible input, including patterns in the key changes, and device 101 may automatically update the pitch palette that is presented to the user in accordance with the identified patterns.

By using audible inputs to automatically select and update the pitch palette of available notes, device 101 allows someone with little or no musical training to play along with others in a more enjoyable and consonant manner. For example, device 101 could be used as a training tool for children to learn about music by having them play along with music that is being played around them. Even if the surrounding music that is being played is relatively complex, device 101 can identify a particular set of notes that would be most conducive for harmonizing with that music and then automatically make those notes available to the user as a pitch palette. In addition, by providing relative intervallic inputs for selecting notes within the pitch palette, a novice can more easily move to higher or lower notes while maintaining a level of harmonization. Thus, someone who is not trained in music would be able to participate in playing with others who are highly trained and can create new music based on the sounds heard in the user's environment.

In accordance with aspects of the disclosure, device 101 can be set to one of a plurality of different levels of musical complexity. The complexity level of device 101 can determine the type of pitch palette that is selected and provided to a user. For example, if the user is a young child without any musical training, device 101 can be set to a low complexity level, whereby very simple pitch palettes are provided. These pitch palettes may be constructed to reduce the amount of dissonance that can be created relative to the pitch-related input. For example, when device 101 is in a low complexity setting, it may provide a user with a pitch palette that consists of pitches within a particular pentatonic scale, while in a higher setting can include additional steps within the scale. In addition, a high complexity setting may allow device 101 to provide the user with a pitch palette that includes at least some microtonal steps that are smaller than the half-steps that are typically used in western music. The low complexity setting may also allow the user to select the available lengths of each note that are to be played by the device, such as by having the device only play quarter notes, or only play quarter notes and half notes. Thus, device 101 can be configured to be played by a wide variety of individuals irrespective of their musical knowledge and training. In accordance with aspects of the disclosure, a user may also select their own pitch palette or create a new pitch palette that is to be played by device 101.

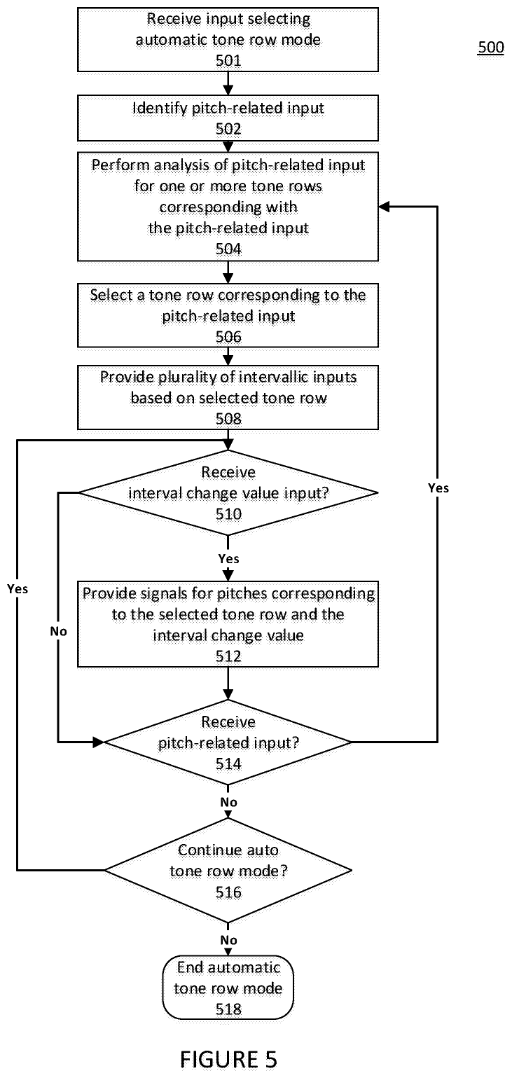

FIG. 5 is a flow diagram 500, which provides various operations that may be performed in accordance with aspects of the disclosure. The operations of flow diagram 500 may be performed by devices that are described herein, such as device 101. In addition, one or more operations of flow diagram may be performed by other devices that are a part of a system with device 101. Where applicable, particular operations may be removed or added in accordance with aspects of the disclosure. In addition, particular operations may be performed in a different order or simultaneously with one another in accordance with aspects described herein.

In accordance with operation 501, the device may receive an input that corresponds to placing the device in an automatic pitch palette mode of operation. This input could take the form of the user selecting an automatic pitch palette mode on a display screen or by selecting a designated user input for placing the device into the automatic pitch palette mode. In accordance with operation 502, the device may identify pitch-related inputs. These pitch-related inputs may take the form of audible inputs that are received by a microphone of the device. The pitch-related inputs may also take the form of a communication signal from another device or user input that identifies a particular piece of music or contains information regarding one or more pitches.

An analysis of the pitch-related input may be performed by the device in accordance with operation 504. If the pitch-related input is of the form of audible inputs, the device may identify one or more pitches within the audible inputs. This analysis may also include identification of whether the audible inputs correspond to a particular key or a particular combination of pitches, as well as identifying whether the audible inputs correspond to a particular instrument or corresponds to multiple instruments or multiple sources of sound. If the audible inputs correspond to multiple sources of sound, the analysis of operation 504 may include identifying pitches from particular sources of sound. For example, if the audible inputs include sounds from multiple instruments and vocal sounds from multiple voices, the device may be configured to determine what pitches were produced by each of the instruments and each of the voices. In addition, the audible inputs may be compared against a database of music to determine if the audible inputs correspond to a particular musical piece or a particular series of sounds.

Based on this analysis, the device may identify one or more pitch palettes that correspond to the pitch-related inputs. If multiple sources of sound are provided, the device may identify a potential pitch palette for each source. If the pitch-related input is identified as being a particular piece of music, the pitch palette or plurality of pitch palettes may be based on the key or series of keys of the piece. This information may be accessed by reviewing a database of music.

The analysis for identifying the one or more pitch palettes in operation 504 may also be performed based on a machine learning algorithm. For example, the device, or a system in communication with the device, may be configured with a machine learning algorithm that has been trained to identify pitch palettes for pitch-related inputs. This machine learning algorithm could be trained using musical pieces that have been designated with one or more pitch palette identifiers. Upon being trained with a sufficient number of designated musical pieces, the machine learning algorithm could be used to identify potential pitch palettes from any pitch-related input, including audible inputs received at the device.

In accordance with operation 506, the device selects a pitch palette corresponding to the pitch-related input. This selection may be automatically performed by the device based on the analysis of operation 504. The selection may also be performed based on user input. For example, if a plurality of potential pitch palettes are identified in connection with operation 504, the device could display or otherwise present the plurality of pitch palettes to the user, who can then provide an input to the device that selects one of the potential pitch palettes. As discussed above, the device may identify different pitch palettes for different sources of sound within the pitch-related input. In this instance, the device could present the user with identification of each source of sound, along with an identified pitch palette associated with that source. The user may then select a pitch palette based on the source of sound. For example, if the pitch-related inputs include pitches from both a vocal input and piano input, the user could select the pitch palette that is associated with the piano.

In accordance with operation 508, a plurality of intervallic inputs are presented based on the selected pitch palette. As described herein, the intervallic inputs may be presented as pitch values based on the number of intervals or steps within the pitch palette from another pitch. For a sequence of pitches, the intervallic inputs can identify a pitch to be played based on the number of intervals from the previous pitch within the sequence. Thus, various intervallic inputs may not have a specific pitch value that remains constant throughout the sequence, as the pitch values for a given intervallic input would be based on the pitch value of the prior pitch within the sequence. The device may determine whether it has received an interval change value input in accordance with operation 510. An interval change value input may take the form of the user pressing a particular button, switch, or key that corresponds to a predetermined intervallic change value. In accordance with the disclosure, the interval change value may consist of a plurality of interval change values, so that multiple notes are played simultaneously. Thus, a user can select multiple interval change value inputs in order to play chords or other combinations of notes. If a user input corresponds to a change value of zero, then the same note may be repeated in connection with the selection of that input.

If an interval change value input has been received, the device can provide signals for playing the one or more pitches that correspond to the received interval change values within the pitch palette. Thus, the pitches that are provided by the device in operation 512 will be based on the pitches that are available within the selected pitch palette. As described herein, the pitches may be audibly played by the device in a manner that simulates one or more instruments. If an interval change value input is not received, the device need not provide a signal for any pitch.

In accordance with operation 514, it is determined whether additional pitch-related input has been received. For example, if the pitch-related input identified in connection with operation 502 is audible input, the device may continue to receive audible input during the performance of the subsequent operations. If additional pitch-related input is received, the device may be configured to perform an analysis on the additional pitch-related input in accordance with operation 504, and in accordance with operation 506 a new pitch palette may be selected based on the analysis of the additional pitch-related input. Thus, the device can be configured to automatically update the selected pitch palette while the device is being played by the user.

In accordance with operation 516, if the device continues to be in the automatic pitch palette mode of operation, then the device can continue to respond to interval change value inputs and pitch-related inputs in accordance with operations 510 and 514. However, the user may provide an input indicating that the device should exit the automatic pitch palette mode, where upon the device can end the automatic pitch palette mode of operation in accordance with operation 518.

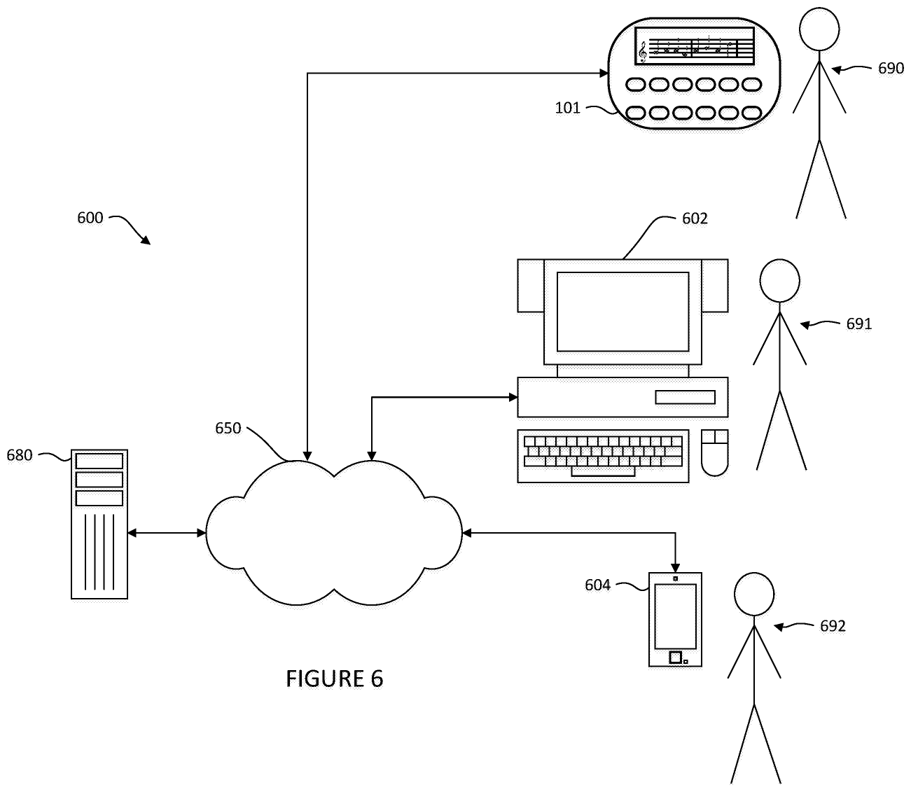

FIG. 6 is a block diagram of a system 600 that can be configured to operate in accordance with aspects of the disclosure. System 600 can include a plurality of user devices, such as devices 101, 602, and 604, which may be operated by one or more users 690-692. The devices 101, 602, and 604 may be in communication with one or more servers 680. The communication links 650 of system 600 may include any number of transmission types, including cellular, Bluetooth, WI-FI, Internet routers, and other online communication links. In addition, each of devices 101, 602, and 604 may be in communication with each other via one or more transmission types within communication links 650. Device 101 may be configured in the manner recited above in connection with FIGS. 1-4. This device may be handheld and portable. Device 602 may be a desktop or laptop computer, while device 604 may be a handheld smartphone or other handheld computing device. Devices 602 and 604 may be configured to receive the same type of inputs as described above in connection with device 101. For example, the user 692 of handheld device 602 may download an application onto handheld device 602 so that it is configured to operate in the same or a similar manner as described herein for device 101. In particular, handheld device 602 may include a touchscreen that can be configured to display similar types of user inputs and provide similar display as those described in connection with device 101.

In accordance with embodiments of the disclosure, devices 101, 602, and 604 may communicate with servers 680 in order to obtain data from the server or to have particular processing performed by the server in connection with one or more operations described herein. For example, servers 680 may include a database of music that can be accessed by devices 101. 602, and 604. Servers 680 may also contain various pitch palette designations for particular pieces of music. Accordingly, the analysis of pitch-related inputs by devices 101, 602, and 604 may include communicating with servers 680 to receive pitch palettes that are associated with particular pieces of music or with particular sequences of pitches. In addition, if a machine-learning algorithm is used to identify the pitch palettes for a particular pitch-related input, the machine-learning algorithm may reside on servers 680, so that the processing associated with analyzing the pitch-related inputs is performed on servers 680. The servers 680 may then provide devices 101, 602 or 604 with the one or more pitch palettes that are identified as corresponding to the pitch-related inputs.

In addition, devices 101, 602, and 604 may communicate with each other so as to provide particular inputs. For example, device 604 could provide device 101 with pitch-related input in the form of a particular piece of music, either by sending the piece electronically, playing the piece audibly, or by identifying the piece based on its name or other information. This pitch-related input form device 604 can then be used by device 101 to identify and select a particular pitch palette as described above. Thus device 101 can be automatically configured to play music in accordance with a pitch palette that is based on signals provided by device 604.

Device 101 may also be configured to generate an interval pattern in which the device can cycle through a series of intervals in a pattern. The generation of the interval pattern can occur by the user providing an input, such as by pressing and holding (or releasing) a particular button while also selecting various intervallic inputs. Thus, the user can place device 101 into an interval pattern generation mode. The device can then play back the generated pattern of intervals in accordance with a particular clock signal or identified rhythm, which can be either an internally stored rhythm or a rhythm that is identified from external signals.

When device 101 is placed into an interval pattern generation mode, the device can be configured to track events within a cycle, such as the change in interval, the duration of the pitch, and the velocity of the pressed intervallic inputs. These events can be tracked against a clock, such as a clock that is based on internal or external signals. For example, the clock could be set so that each pulse of the clock corresponds to a duration of a quarter note. The changes in intervals can be entered by the user pressing intervallic inputs. An interval change can be recorded each time the user presses an intervallic input. For example, if the user were to press a pattern generation input while also holding the +1, −3, −1, and +5 intervallic inputs in a sequence, this interval pattern could be repeated within a cycle. Moreover, the user could activate the pattern generation input for a period of 16 events, so that the intervallic changes of +1, −3, −1, and +5 are repeated four times within the cycle.

If a seven-step scale has been identified as the pitch palette, then the particular interval change sequence of +1, −3, −1, and +5 would not cause the resulting pitches played by device 101 to be reproduced after each four events. Instead, the repeating intervals would produce resulting pitches that have a pattern that repeats every 28 events, as it would take seven cycles for this sequence of interval changes to repeat through the entirety of the seven-step scale. Similarly, a 12-step scale would repeat after 12 cycles, meaning after a total of 48 events.

While device 101 is in a pattern generation mode, the user may can change the specific intervallic inputs that are being held down, and the cycle of repeated events can change in accordance with the new set of intervallic inputs. In addition, the device 101 can be configured so that the pattern cycle stops upon the user releasing the inputs that are being held. Pattern variations and permutations may be driven by additional cycle and event functions, which can be implemented based on direct user input via hardware or GUI. Alternatively, predetermined cycle and event data can be made available to the user as presets, in which the cycle and event functions can create complex pattern variations that are produced in accordance with the preset over many bars of musical time. Many of these functions can be selectively randomized within a variable range. Different probability values can be set for any function that is randomized as a way of deepening the range of variations and permutations.

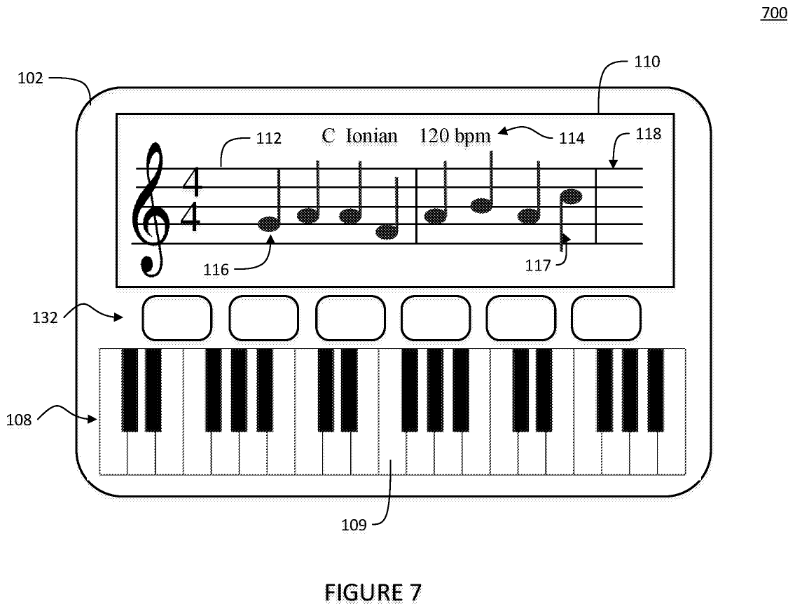

In accordance with other embodiments, the device 101 may include or may be converted to include user inputs that resemble or are based on the inputs of a particular musical instrument. For example, block diagram 700 of FIG. 7 shows a device 102, which includes a set of piano keys 108. These piano keys can operate in the standard manner of a piano key in which each key corresponds to a particular pitch. In addition, device 102 can be configured so that it can switch from a standard piano mode to an intervallic playing mode in which at least a subset of the keys correspond to a predetermined interval step within a pitch palette, relative to a previously played pitch. For example, in the intervallic mode, key 109 may correspond with an interval step value of zero, while keys to the right of key 109 correspond to an increased interval step and keys to the left of key 109 correspond to a decreased interval step in connection with a selected pitch palette. Device 102 may also include a plurality of additional user inputs 132, which can be configured to provide intervallic inputs, or which can be configured to provide other inputs to device 102.

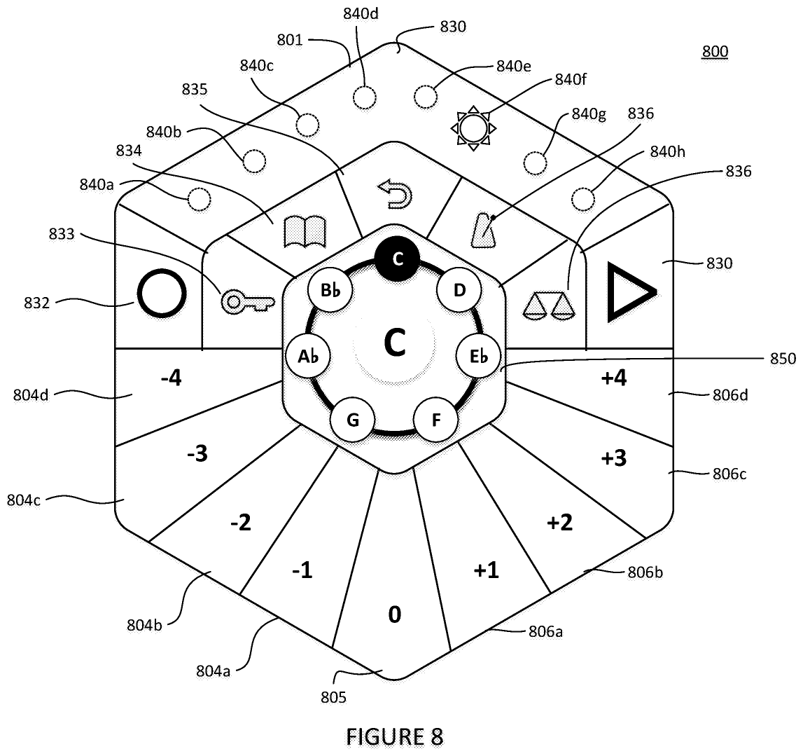

FIG. 8 is a front view 800 of a device 801 that has a different user interface than device 101 of FIG. 1, but which is similarly configured to automatically analyze pitch-related input, including audible input, and may provide pitch palettes based on the pitch-related input in manners described herein. As shown in front view 800, device 801 may have a plurality of user inputs 830-837, as well as intervallic user inputs 804a-d, 805, and 806a-d. As described above, these intervallic inputs 804-806 are configured to allow the user to play a note that is a particular number of intervallic steps (e.g., 0, +/−1, +/−2, +/−3, +/−4 . . . ) from the previously played note. Device 801 may also include a

In addition, device 801 may contain a display area 830 that indicates the overall octave level of the device. For example, display area 830 has eight LED lights 840a-h, with each LED light 840a-h representing a different octave level that is currently being played. These octave levels may increase from left to right so that LED light 840a represents the lowest available octave while LED light 840h represents the highest available octave. As shown in front view 800, device 801 is currently within a mid-ranged octave designated by LED light 840f being lit. The regions associated with LED lights 840a-h may also be user inputs, so that the user may select a desired octave for device 801 by pressing a location within display area 830 that is at or around one of the LED lights 840a-h.

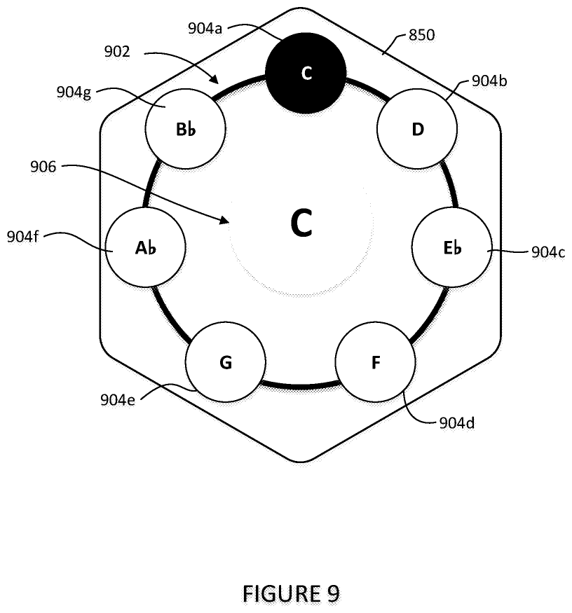

Device 801 also has a display 850, which can identify the last note played by device 801, as well as the notes within the currently-available pitch palette. For example, FIG. 9 is representation of display 850 in which a pitch wheel 902 is displayed. Included within the pitch wheel 902 are a plurality of available notes 904a-g. Theses available notes 904a-g make up the available pitch palette that can currently be played by the user selecting one or more of the intervallic user inputs. In the example provided, the available pitch palette consists of the notes C, D, E-flat, F, G, A-flat, and B-flat. Pitch wheel 902 can be configured to indicate which note has most recently been played by highlighting a particular note 904a-g within the pitch wheel 902. In FIG. 9, note 904a is highlighted and a “C” appears within region 906 of display 850, indicating that a C note was the most recently played note. Display 850 can also be configured to locate a root note for the pitch palette at a predefined location. For example, in FIG. 9, the root note is placed at the top of the display within the location for note 904a.

As discussed above, the number of pitches available within a particular pitch palette may vary. Display 850 may be configured to alter pitch wheel 902 so that it only displays the available notes within a given pitch palette. For example, in FIG. 9, seven notes 904a-g are displayed, however if the device were to transition to a pitch palette that had only five notes, pitch wheel 902 can be altered so that it displays a total of five notes.

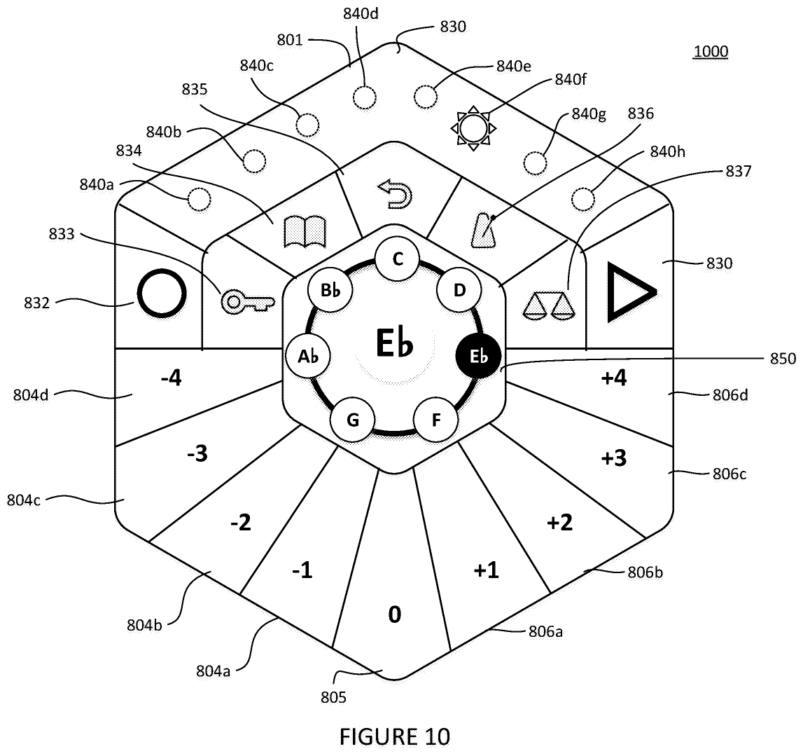

By placing the notes 904a-g within pitch wheel 902, display 850 provides a user with a simple display that easily indicates how many intervallic steps are present between any pair of notes within the available pitch palette. This allows for even a beginner to easily select various notes using intervallic user inputs. For example, returning to FIG. 8, if intervallic user input 806b is selected by the user, device 801 will play a note that is two intervallic steps above the most recently played C note. For the currently available pitch palette, the note that is two intervallic steps above the C note is shown as being the note E-flat. Accordingly, upon pressing intervallic user input 806b, device 801 will play an audible output having the pitch of E-flat. In addition, the pitch wheel of display 850 will be updated to indicate that E-flat is the most recently played pitch. This can be seen in the diagram 1000 of device 801 shown in FIG. 10.

As described herein, display 850 can be altered to provide the user with various information regarding the settings and operation of device 801. In addition, display 850 may be configured to be a touch-sensitive screen that can be used for selecting particular settings. For example, the user can alter the setting of device 801 by selecting portions of display 850. based on the display being provided by touch-sensitive display 850.

In an embodiment of the disclosure, a user of device 801 can alter the intensity of a note or bend a note around a particular pitch by placing the user's fingers at different locations within intervallic user inputs 804-806. For example, When pressing intervallic user input 806b in order to have device 801 play the note E-flat, the user could press intervallic user input 806b at a location that is towards the center of device 801, thereby causing device 801 to play the E-flat note with a louder intensity than if intervallic user input 806b were pressed at a location towards the outer-edge of device 801. Alternatively, a user could bend the E-flat note by sliding his or her finger along the intervallic user input 806b in one or more directions.

With regard to the other user inputs 830-837. User input 830 is a play button, which can be used to play a particular set of recorded sounds or a particular piece of music, and user input 832 is a record button that can be used to record sounds that are being played by device 801 and/or can be used to record audible input that is being received by device 801. The recording and playing of sounds using user inputs 830 and 832 may include the ability to record and play sounds on a loop, so as to generate repeating musical phrases or pieces.

User input 833 is a pitch palette or key selection input, which can be selected in order for the user to select a particular key for the available pitch palette. For example, display 850 may change upon the user selecting user input 833 so as to provide the user with a plurality of keys that can be selected by the user. The user can select one of the available keys by pressing a designated area within display 850, such as by selecting particular locations within a key wheel provided to the user. In addition, device 801 can be configured such that when a user holds down user input 833, the user is given access to chords, whereby multiple notes can be selected in order to produce a particular chord that is desired by the user.

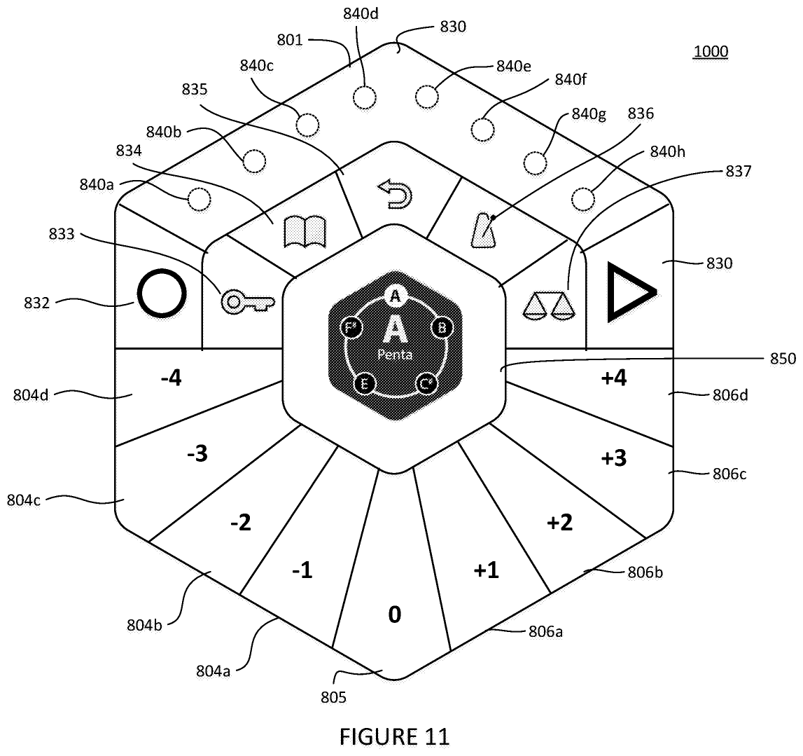

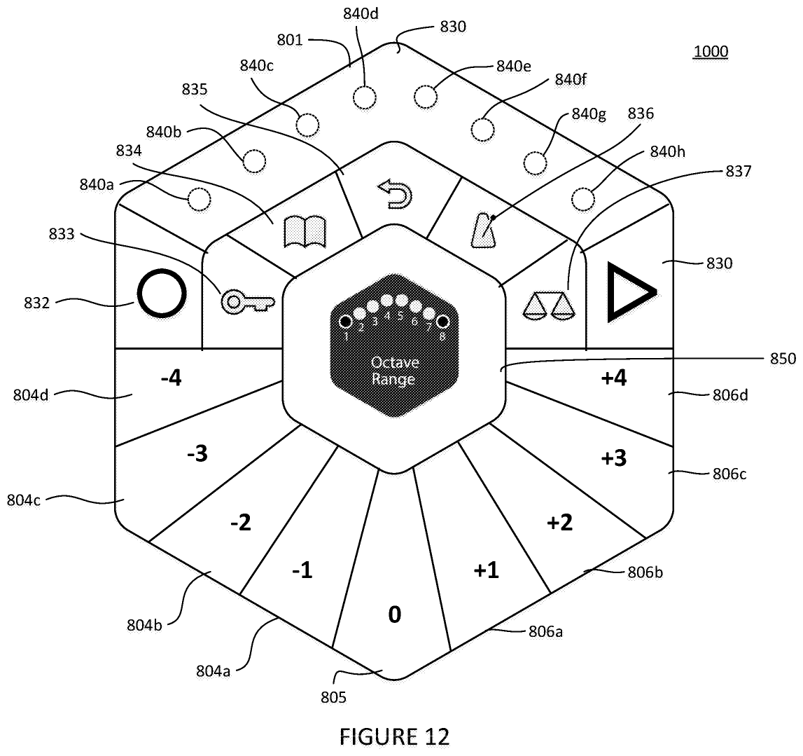

Selection of user input 837 can be used to alter the pitch palette by having it correspond to a particular type of scale. For example, pressing user input 837 can cause display 850 to display selectable options for whether the pitch palette will be based on a standard seven-note scale, a pentatonic scale, or a chromatic scale. In FIG. 11, display 850 is providing a display indicating that the user has selected a pentatonic scale containing five notes. In addition, by holding down user input 837, device 801 may present the user with an option for selecting an octave range. For example, in FIG. 12, the user has selected and held user input 837 so as to cause display 850 to provide a selectable range of octaves, and the user has selected the middle octaves 2-7. Thus, device 801 will be placed into a mode wherein the intervallic keys will only produce notes that are within the selected octaves.

Selection of user input 834 can cause display 850 to provide options of instruments or particular types of sounds for which device 801 will simulate when being played. For example, pressing user input 834 can result in display 850 providing a list of instruments, including such as guitar, piano, drums, and trumpet. Device 801 may also be configured so that the user can alter the sound of a particular instrument, such as by making the instrument sound coarser or having more distortion. Device 801 may also have a plurality of preset sound combinations that can be displayed and selected by the user.

Selection of user input 836 can allow the user to set the tempo of the music, such as by setting an electronic metronome. The metronome may be configured to provide audible taps indefinitely or for a predetermined period of time. A user may also press and hold user input 836 so as to put device 801 into a timekeeper mode, wherein it will receive time sync information from another device or from audible input that it receives from the environment.

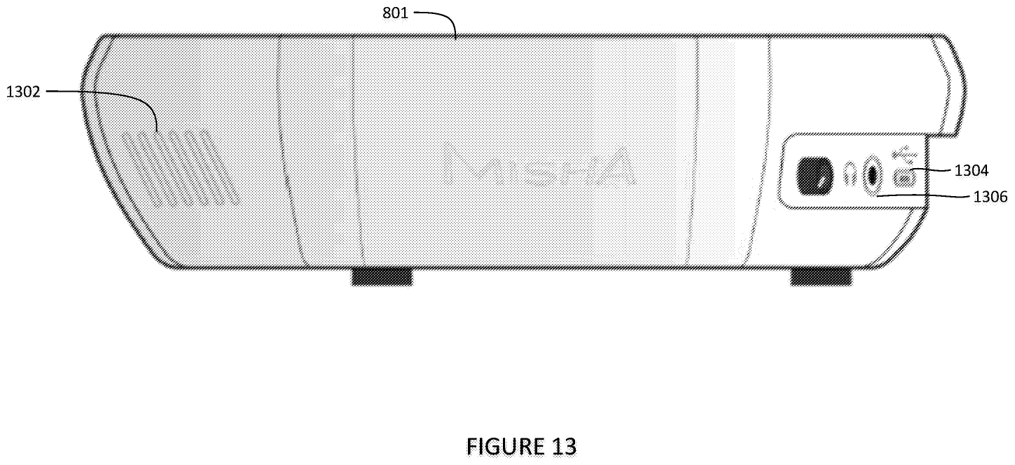

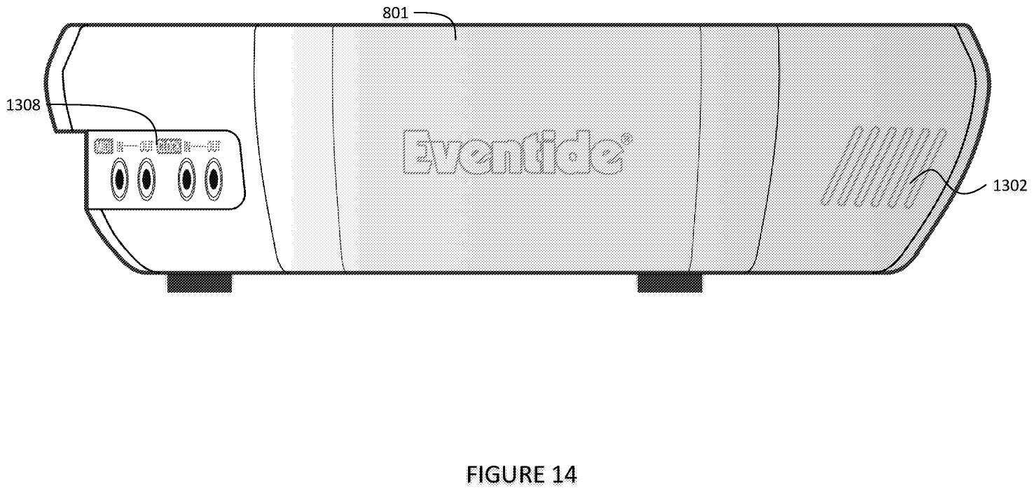

FIGS. 13 and 14 are side views of device 801. As can be seen from these side views, device 801 can include speakers 1302, as well as various input/output connections 1304-1308. For example, as shown in FIG. 13, device 801 may include a USB or other input/output connector and may also include an audio jack output 1306. In addition, as shown in FIG. 14, device 801 may include input/output jacks that include input/output for MIDI and clock signals. In addition, Device 801 may have the functionality described above in connection with device 101, including the ability to communicate with other devices via Wi-Fi, Bluetooth, or cellular transmissions.

The systems and methods described herein refer to devices performing operations using one or more processors. The one or more processors may be programmable processors that perform operations based on retrieved instruction sets. In addition, the processors may include any type of controller, including controllers that are based on hardware and are not programmable. The one or more processors may be configured to be one or more computer processing units that are based on a combination of hardware, software, and firmware.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for playing music comprising one or more processors, wherein the one or more processors are configured to:
receive a first set of signals corresponding to a first audible input;
identify, based on the first set of signals, one or more pitches within the first audible input;
determine a first pitch palette corresponding to the one or more pitches;
receive user input at a device having a plurality of device inputs, wherein each of the plurality of device inputs are associated with a predetermined interval change value within the first pitch palette; and
provide a first plurality of output signals corresponding to a first sequence of output pitch values, wherein each of the output pitch values are within the first pitch palette, and wherein at least a subset of the output pitch values are based on the predetermined interval change value of the user input relative to a previous pitch value within the first sequence.

2. The system of claim 1, wherein one or more processors are further configured to:
receive a second set of signals corresponding to a second audible input;
identify, based on the second set of signals, one or more pitches within the second audible input;
determine a second pitch palette corresponding to the one or more pitches of second audible input;
receive user input at the device from the plurality of device inputs;
provide a second plurality of output signals corresponding to a second sequence of output pitch values, wherein each of the output pitch values of the second sequence are within the second pitch palette.

3. The system of claim 2, wherein the first pitch palette corresponds to a first set of notes within a scale of a first musical key, wherein the second pitch palette corresponds to a second set of notes within a scale of a second musical key.

4. The system of claim 1, wherein the first audible input includes a plurality of sound sources and wherein identifying the one or more pitches within the first audible input further comprises identifying a sound source, from the plurality of sound sources, for each of the one or more pitches.

5. The system of claim 4, wherein identifying the sound source for each of the one or more pitches includes identifying an instrument type for the one or more pitches.

6. The system of claim 1, wherein the one or more processors are further configured to place the device into a musical complexity mode from a plurality of musical complexity modes, and wherein the first pitch palette is determined, at least in part, by the musical complexity mode.

7. The system of claim 6, wherein the processors are further configured so that when the device is in a first musical complexity mode, the first pitch palette is based on a pentatonic scale, and wherein when the device is in a second musical complexity mode, the first pitch palette has more than five notes.

8. The system of claim 1, wherein the one or more processors are further configured to provide the first audible input to a machine-learning algorithm that has trained using music data that has been associated with particular pitch palettes, and wherein the first pitch palette is based on an output of the machine-learning algorithm.

9. The system of claim 1, wherein the one or more processors are further configured to provide for display on the device an indication of the first pitch palette.

10. A method for playing music on a device comprising:
receiving, by one or more processors, a first set of signals corresponding to a first audible input;
identifying, by the one or more processors, one or more pitches within the first audible input;
determining, by the one or more processors, a first pitch palette corresponding to the one or more pitches;
receive, by the one or more processors, user input at a device having a plurality of device inputs, wherein each of the plurality of device inputs are associated with a predetermined interval change value within the first pitch palette; and
provide, by the one or more processors, a first plurality of output signals corresponding to a first sequence of output pitch values, wherein each of the output pitch values are within the first pitch palette, and wherein at least a subset of the output pitch values are based on the predetermined interval change value of the user input relative to a previous pitch value within the first sequence.

11. The method of claim 10, further comprising:
receiving, by the one or more processors, a second set of signals corresponding to a second audible input;
identifying, by the one or more processors, one or more pitches within the second audible input;
determining, by the one or more processors, a second pitch palette corresponding to the one or more pitches of second audible input;
receiving, by the one or more processors, user input at the device from the plurality of inputs;
providing, by the one or more processors, a second plurality of output signals corresponding to a second sequence of output pitch values, wherein each of the output pitch values of the second sequence are within the second pitch palette.

12. The method of claim 11, wherein the first pitch palette corresponds to a first set of notes within a scale of a first musical key, wherein the second pitch palette corresponds to a second set of notes within a scale of a second musical key.

13. The method of claim 10, wherein the first audible input includes a plurality of sound sources and wherein identifying the one or more pitches within the first audible input further comprises identifying a sound source, from the plurality of sound sources, for each of the one or more pitches.

14. The method of claim 13, wherein identifying the sound source for each of the one or more pitches includes identifying an instrument type for the one or more pitches.

15. The method of claim 10, further comprising placing the device into a musical complexity mode from a plurality of musical complexity modes, and wherein the first pitch palette is determined, at least in part, by the musical complexity mode.

16. The method of claim 15, wherein when the device is in a first musical complexity mode, the first pitch palette is based on a pentatonic scale, and wherein when the device is in a second musical complexity mode, the first pitch palette has more than five notes.

17. The method of claim 10, providing, by the one or more processors, the first audible input to a machine-learning algorithm that has trained using music data that has been associated with particular pitch palettes, and wherein the first pitch palette is based on an output of the machine-learning algorithm.

18. The method of claim 10, providing for display on the device an indication of the first pitch palette.

19. A system for playing music comprising one or more processors, wherein the one or more processors are configured to:
receive a first set of signals corresponding to a first pitch-related input;
determine a first pitch palette of available pitches corresponding to the first pitch-related input;
associate a plurality of device inputs with the first pitch palette of available pitches, wherein each device input corresponds with a predetermined interval change value relative to a previously-played pitch value;
receive user input selecting one of the plurality of device inputs;
provide a signal for a pitch to be played that corresponds with the user input;
receive a second set of signals corresponding to a second pitch-related input;
determine a second pitch palette of available pitches corresponding to the second pitch-related input; and
associate the plurality of device inputs with the second row of available pitches.

20. The system of claim 19, wherein at least one pitch is a part of either the first pitch palette or the second pitch palette, but is not a part of both the first pitch palette and the second pitch palette.
